(19) United States
(12) Patent Application Publication
(10) Pub. No.: US 2014/0344220 A1
(43) Pub. Date: Nov. 20, 2014

(54) DEVICE-AWARE FILE SYNCHRONIZING METHOD

(71) Applicants: Fong-Yuan CHANG, (US); Sheng-Hsiung CHEN, (US); Chun-Chen CHEN, (US); Ru-Lin YANG, (US); Hsiang-Ho CHANG, Miaoli County (TW)

(72) Inventors: Sheng-Hsiung CHEN, Hsinchu City (TW); Fong-Yuan CHANG, Hsinchu County (TW); Chun-Chen CHEN, Hsinchu County (TW)

(73) Assignees: Fong-Yuan CHANG, Hsinchu County (TW); Sheng-Hsiung CHEN, Hsinchu city (TW); Chun-Chen CHEN, Hsinchu County (TW); Ru-Lin YANG, Hsinchu City (TW); Hsiang-Ho CHANG, Miaoli County (TW)

(21) Appl. No.: 14/274,482

(22) Filed: May 9, 2014

(30) Foreign Application Priority Data
May 16, 2013 (TW) 102117385

(51) Int. Cl. G06F 17/30

(52) U.S. Cl. CPC G06F 17/30174
USPC 707/626

(57) ABSTRACT

A device-aware file synchronizing method is disclosed. After a user creates an original file such as a photo or a film via a user terminal, the original file is synchronized and saved to the web storage server via an interconnected network. Next, the web storage server adjusts the original file and generates an adjusted file according to the type of the original file, or capabilities of the device to synchronize with such as computing capability, display capability and storage capability. Then, the adjusted file is synchronized to the devices via the interconnected network. According to the present invention, files of different sizes are respectively generated according to the capabilities of each device to synchronize with, then the files are synchronized to each device. Thus, the file quantity synchronized by each device is effectively increased.

### FIELD OF THE INVENTION

The present invention relates to file synchronizing mechanisms, in particular further relates to a synchronizing method which a file is adjusted then synchronized to different devices according to capabilities of the different devices.

### DESCRIPTION OF PRIOR ART

Today, the electronic devices become more and more popular, electronic devices such as notebook computers, tablets and smart phones are daily necessities as a result of the convenience of using these devices. In addition, some users have different electronic devices for different usages so as to handle personal matters anytime anywhere. Also, for the purpose to access to the same file via different electronic devices. Accordingly, a file synchronizing mechanism is required for the user of the above type.

Currently, the most frequently seen file synchronizing mechanism is primarily implemented by replicating a complete file to other devices via cloud drives (for example Dropbox, Google Drive etc.). However, mobile devices, such as smart phones, have a storage space much smaller than the storage space of cloud drives or desk top storage devices. If all files are completed synchronized, the mobile devices soon may have insufficient storage space.

Further, certain synchronizing applications mandatorily replicate a copy of the file the user want to synchronize from the storage space to the synchronous area of the electronic device, then use the file in the synchronous area for synchronizing in order to facilitate execution of synchronizing applications. Accordingly, there are two identical files saving in the electronic device, and the storage space of the electronic device becomes insufficient even sooner.

### SUMMARY OF THE INVENTION

The main objective of the present invention is to provide a device-aware file synchronizing method, which adjusts the file according to the capabilities of the device to synchronizing then synchronizes the file. Thus the file quantity synchronized by each device is increased.

Another objective of the present invention is to provide a device-aware file synchronizing method, which it is selected if to synchronize an original file or an adjusted file to each device according to user's using habits, so as to assure each device uses the file effectively.

In order to achieve the above objectives, according to the present invention, after a user creates an original file such as a photo or a film via a user terminal, the original file is synchronized and saved to the web storage server via an interconnected network. Next, the web storage server adjusts the original file and generates an adjusted file according to the type of the original file, or capabilities of the device to synchronize with such as computing capability, display capability and storage capability. Then, the adjusted file is synchronized to the devices via the interconnected network.

Compare with prior arts, the present invention provides advantages that the original files are retained on web storage servers, and replicated files of different sizes are generated and transmitted to each device depending on capabilities of different devices during synchronization. Thus, network transmission time is reduced and required storage space for synchronizing the file on each device is reduced.

Meanwhile, it is determined if the original file should or the adjusted file should be synchronized to each device according to user's using habit. Thus the usage storage space in each device is optimized, and storage space does not become insufficient because there are many synchronizing files generated.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a synchronizing architecture diagram according of the first preferred embodiment of the present invention;

FIG. 2 is a synchronizing architecture diagram according of the second preferred embodiment of the present invention;

FIG. 3 is a file synchronizing flowchart of the first preferred embodiment of the present invention;

FIG. 4 is a web storage server block diagram of the first preferred embodiment of the present invention;

FIG. 5 is a file uploading flowchart of the first preferred embodiment of the present invention;

FIG. 6 is a file downloading flowchart of the first preferred embodiment of the present invention;

FIG. 7 is a file deleting flowchart of the first preferred embodiment of the present invention;

FIG. 8 is a file modifying flowchart of the first preferred embodiment of the present invention;

FIG. 9 is a storage device perspective diagram of the first preferred embodiment of the present invention; and

FIG. 10 is a file uploading flowchart f the second preferred embodiment of the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

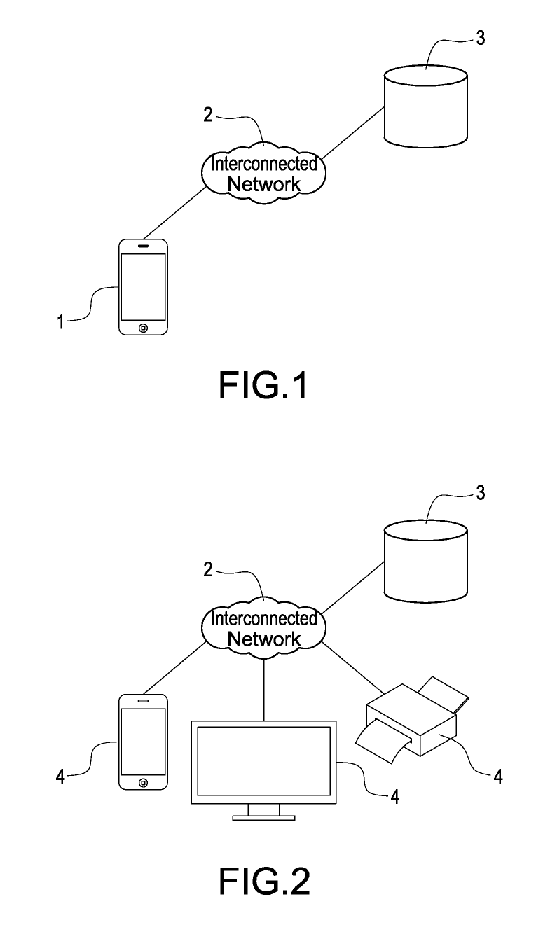

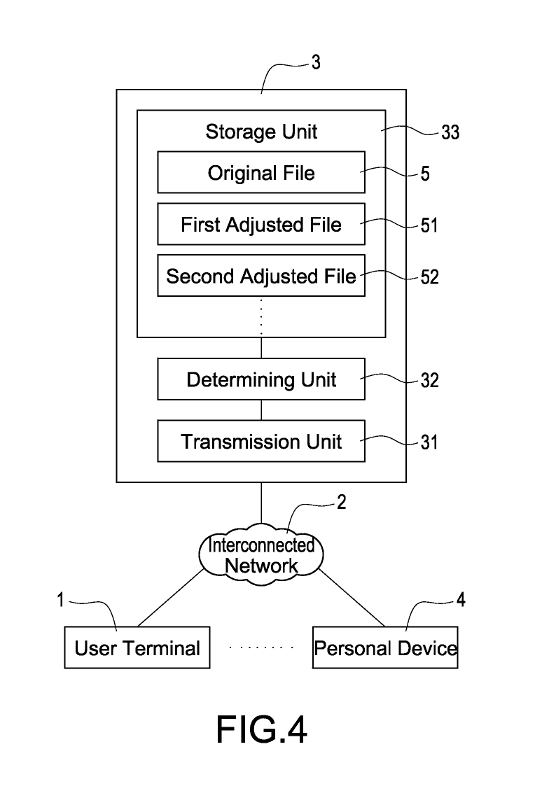

FIG. 1 is a synchronizing architecture diagram according of the first preferred embodiment of the present invention. The present invention discloses a device-aware file synchronizing method. A user terminal 1 operated by a user connects to a web storage server 3 via an interconnected network 2. After the user creates an original file (as an original file 5 shown in FIG. 4) via the user terminal 1, the original file 5 is synchronized to the web storage server 3 via the interconnected network 2.

In the embodiment, the user terminal 1 is a mobile device, for example a tablet or a smart phone etc., and the original file 5 is, for example, multimedia files such as a photo or a film taken or downloaded by the user terminal 1, but is not limited thereto. The interconnected network 2 is a network where devices are interconnected and data is transmitted, for example various cable networks, wireless networks, mobile networks, and private home networks etc. The web storage server 3 is a storage server connecting to the interconnected network 2, for example network drive service available in the market, such as DropBox, Google Drive etc. Further, the web storage server 3 can be a storage space created by the user, for example disk arrays, hard drive of personal computers, home multimedia entertaining devices etc. connecting to the user terminal 1 through the interconnected network 2.

When the original file 5 is synchronized to the web storage server 3, the user terminal 1 retains the original file 5, or an adjusted file resulted from adjusting the original file 5, wherein the adjusted file has the file size more suited to apply in the user terminal 1. For example, if the original file 5 is a photo, and the screen resolution of the user terminal 1 is lower, then the original file 5 is adjusted to be a file with lower resolution, and retained in the user terminal 1. When the user requires the original file 5 which is not adjusted, the original file 5 can be downloaded from the web storage server 3 to the user terminal 1 anytime.

Further, according to the present invention, it is determined according to user's using habits when the original file 5 should be reduced, adjusted. For example, the user is more likely to use a newly created file and the original type of the file is required, accordingly the original file 5 can be set up to be reduced, adjusted after a specific time period, or the timing to reduce, adjust the original file 5 is determined according to the remaining quantity of the storage space in the user terminal 1.

For example, generally files created by users via mobile devices are multimedia files such as photos, films, or PDF documents etc. The resolution of multimedia files is adjustable and resolution further impacts the file sizes of the multimedia files. Generally speaking, the display of a mobile device (display screen) is smaller. Given the resolution of the multimedia files is reduced, user requirements are not compromised. Accordingly, according to the present invention, the multimedia files are adjusted so as to increase the file quantity synchronized by the mobile devices.

For example, the user takes a photo of 5 million pixels with a camera on a mobile device (digital camera or mobile phone), and the resolution is 2560×1920. At the moment, the original file of the photo can be synchronized to the web storage server 3, then the resolution of the photo is adjusted to 1024×768, and only the photo with resolution of 1024×768 is retained in the mobile device. With the above adjustment, the file size of file is reduced from 1.5 M bytes to about 250K bytes. To a mobile device with small display, the resolution of 1024×768 is sufficient. Therefore, the method contributes to reducing the storage space in the mobile device without effecting user usage. At the same time, because the original file of the photo is saved in the web storage server 3, the user is allowed to download the original file to the mobile device as required and the user's access to the original file of the photo is not affected also.

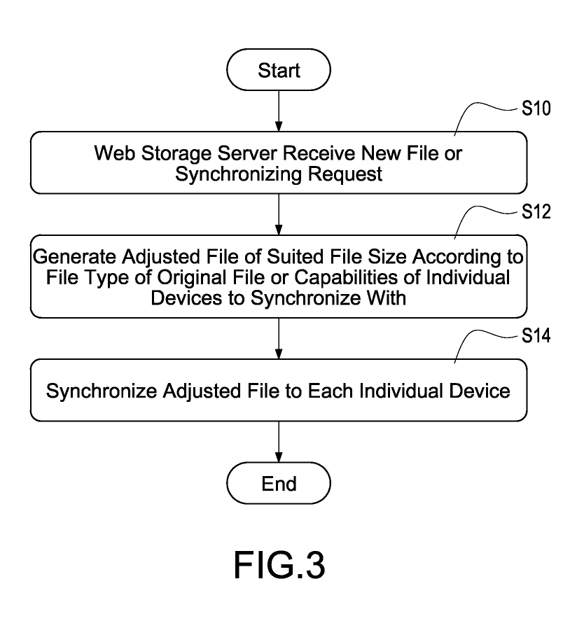

FIG. 2 is a synchronizing architecture diagram according of the second preferred embodiment of the present invention and FIG. 3 is a file synchronizing flowchart of the first preferred embodiment of the present invention. The original file 5 which is synchronized to the web storage server 3 by the user is further synchronized to one or several individual devices 4 such that the user is allowed to use the original file on each of the individual devices 4. In the embodiment, the individual devices 4 are electronic devices connecting to the web storage server 3 via the interconnected network 2. The individual devices 4 for example are a smart phone, a television, a networks printer shown in FIG. 2, even a camera, a tablet, a notebook computer or a desktop computer are not limited thereto.

As shown in FIG. 3, the primary technical feature of the present invention is that when the web storage server 3 receives a new file, or receives a synchronizing request (step S10), the web storage server 3 adjusts the original file 5 and generates an adjusted file of suited file size according to the file type of the original file 5, and/or each capability of the individual devices 4 to synchronize with (step S12). And the adjusted file is synchronized to each individual device 4 via the interconnected network 2 (step S14). In the embodiment, each capability of the individual devices 4 refers to the computing capability, the display capability and the storage capability etc. of the individual devices 4, but is not limited thereto.

For example, if the individual device 4 is a television, when the web storage server 3 is about to synchronize a photo to the television, the web storage server 3 analyzes data about the display size and the resolution of the television, then adjusts the original file 5 to generate an adjusted file with suited resolution, then synchronized the adjusted file to the television for display. In another example, if the individual device 4 is a network printer, when the user has printing demands, the web storage server 3 adjusts the original file 5 according to the resolution of the network printer, then synchronizes the adjusted file to the network printer for printing out the adjusted file. The advantage is that the file size of the adjusted file is smaller than the file size of the original file 5, which shortens the network transmission time. And, the file size of the adjusted file is adjusted according to the resolution of the network printer. As a result, the adjusted file is more suited than the original file 5 to provide to the network printer for printing out.

In further details, the web storage server 3 computes on the original file 5 via a function in order to obtain the most suited file size for the individual device 4. The function variables are the file type of the original file 5, the processor clock of the individual device 4, the display resolution of the individual device 4 and the available storage space of the individual device 4 etc., but are not limited thereto.

FIG. 4 is a web storage server block diagram of the first preferred embodiment of the present invention. The web storage server 3 comprises a transmission unit 31, a determining unit 32 connected with the transmission unit 31, and a storage unit 33 connected with the determining unit 32. The web storage server 3 connects with the interconnected network 2 via the transmission unit 31, in order to receive the original file 5 uploading from the user terminal 1, and replicating the original file 5 or adjusted file to each individual device 4.

When the web storage server 3 performs synchronizing procedures, the determining unit 32 is used for analyzing the file type of the original file 5 and/or the capabilities of each individual device 4 and further determining if the original file 5 should be directly synchronized to each the individual device 4, or the original file 5 should be adjusted then synchronized to each individual device 4. The storage unit 33 is used for saving the original file 5 uploaded from the user terminal 1, and saving one or several adjusted files adjusted and generated from the original file 5 by the web storage server 3.

For example, the web storage server 3 adjusts the original file 5 (for example a film) and generates a first adjusted file 51 according to the capabilities of a first individual device (for example a television), and replicates the first adjusted file 51 to the television. And, the web storage server 3 adjusts the same original file 5 and generates a second adjusted file 52 according to the capabilities of a second individual device (for example a tablet), and replicates the second adjusted file 52 to the tablet. The first adjusted file 51 and the second adjusted file 52 can have different resolutions and different file sizes, and are respectively suited for the television and the tablet.

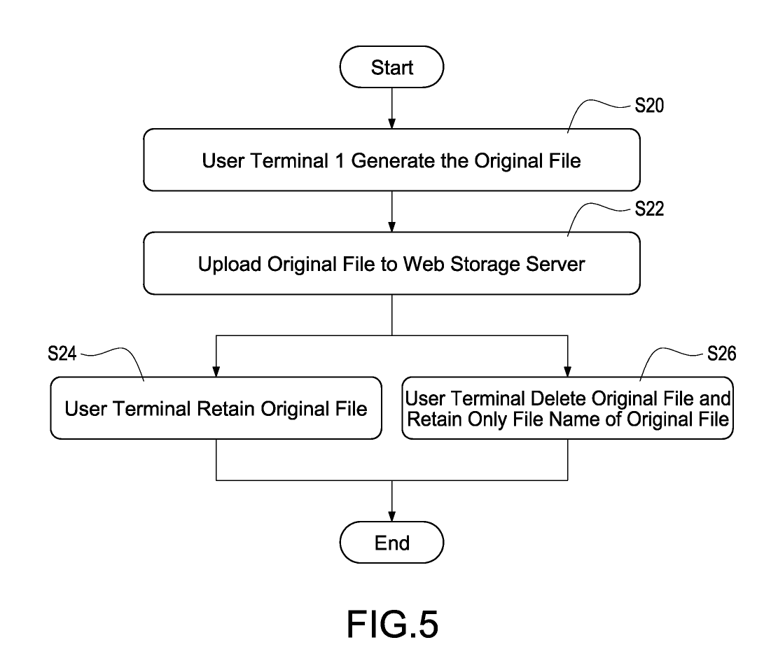

FIG. 5 is a file uploading flowchart of the first preferred embodiment of the present invention. Getting started with the synchronizing method of the present invention, firstly a user is required to operate the user terminal 1 for generating the original file 5 (step S20). And upload the original file 5 to the web storage server 3 (step S22). The original file 5 can be generated in step S20 or a file saved in advance in the user terminal 1, and is not limited thereto.

After the original file 5 is uploaded to the web storage server 3, the following processing step on the original file 5 in the user terminal 1 is determined by the user's demands and/or capabilities of the user terminal 1. For example, if the capabilities of the user terminal 1 is more advanced (for example the display screen is larger, or the storage space is larger), or the original file 5 is a newly created file (presuming newly created file are used frequently), then the user terminal 1 retains the original file 5 (step S24).

In another embodiment, if the storage space of the user terminal 1 is insufficient, or the user desires to retain more storage space, the original file 5 in the user terminal 1 can be deleted, and retains only the file name of the original file 5 in the user terminal 1 (step S26). Thus, the storage space in the user terminal 1 is saved. When the file name of the original file 5 in the user terminal 1 is clicked for execution, the user terminal 1 simultaneously downloads the original file 5 from the web storage server 3 for user's access. It should be noted that, before re-downloading the original file 5 to the user terminal 1, the web storage server 3 adjusts the original file 5 according to the file type of the original file 5 and/or capabilities of the user terminal 1, then synchronizes and downloads the adjusted file to the user terminal 1.

The above is one of the embodiments according to the present invention, but is not limited thereto. For example, if the user simply wants to save the storage space of the user terminal 1, the user can directly delete the original file 5 in the user terminal 1 after the original file 5 is uploaded to the web storage server 3.

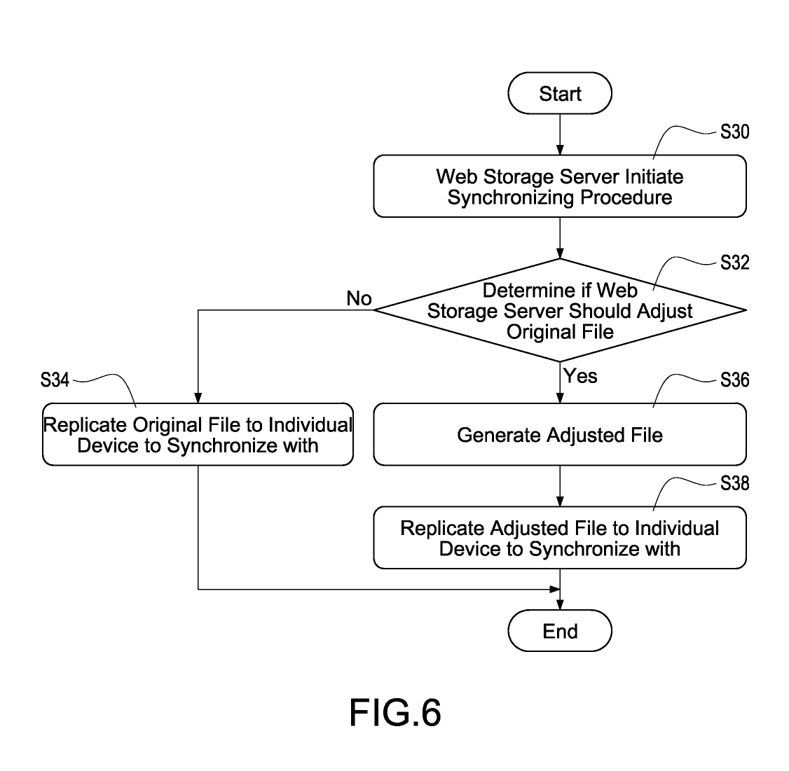

FIG. 6 is a file downloading flowchart of the first preferred embodiment of the present invention. When the web storage server 3 receives a new file, or receives a synchronized request, the web storage server 3 initiates a synchronizing procedure (step S30). In an example synchronizing a file to an individual device 4, before the original file 5 is synchronized to the individual device 4, the web storage server 3 determines if the web storage server 3 should adjust the original file 5 and generate an adjusted file according to the file type of the original file 5, and/or the capabilities of the individual device 4 (step S32).

In the above mentioned step S32, the web storage server 3 determines according to factors such as the file type of the original file 5 (for example a film, a photo or a PDF file etc.), the size of the original file 5, the file created time (a newly created file or an old file) and the using frequency of the original file 5 etc. as well as factors such as the computing capability, the display capability, the storage capability of the individual device 4. The above mentioned examples are preferred embodiments of the present invention, and are not limited thereto.

If in the step S32, the web storage server 3 determines the web storage server 3 should not adjust the original file 5 (for example the file size of the original file 5 is small, or the individual device 4 have advanced capabilities), the web storage server 3 directly replicates the original file 5 to the individual device 4 to synchronize with (step S34) in order to complete the synchronizing procedure.

If the web storage server 3 determines that the web storage server 3 should adjust the original file 5, the web storage server 3 generates the adjusted file based on the adjusting result (step S36). Next, the web storage server 3 replicates the adjusted file to the individual device 4 to synchronize with (step S38) in order to complete the synchronizing procedure.

In the step S32, the web storage server 3 also can determines if the web storage server 3 should adjust the file size of the original file 5 depending on user's using habits. For example, if the original file 5 is a newly created file, the web storage server 3 synchronizes the original file 5 to the individual device 4 directly. In a time period, the web storage server 3 re-determines if the web storage server 3 should adjust the file size of the original file 5 according to the user's using frequency on the file. If the original file 5 is adjusted, the adjusted file is re-synchronized to the individual device 4.

Further, in the step S32, the web storage server 3 also can determines if the web storage server 3 should adjust the file size of the original file 5 depending on the file type of the original file 5. For example, if the original file 5 is an audio and video file, then the web storage server 3 can synchronize part of the original file 5 to the individual device 4. Also, after the user opens the file in the individual device 4, the remaining file content is then downloading to the individual device 4. For example, if the original file 5 is a film of ten minutes, the web storage server 3 then generates the adjusted file (for example the first 30 seconds of the film), and synchronizes the adjusted file to the individual device 4. Till the user opens the adjusted file, the remaining content of the film is downloaded from the web storage server 3 to be watched by the user.

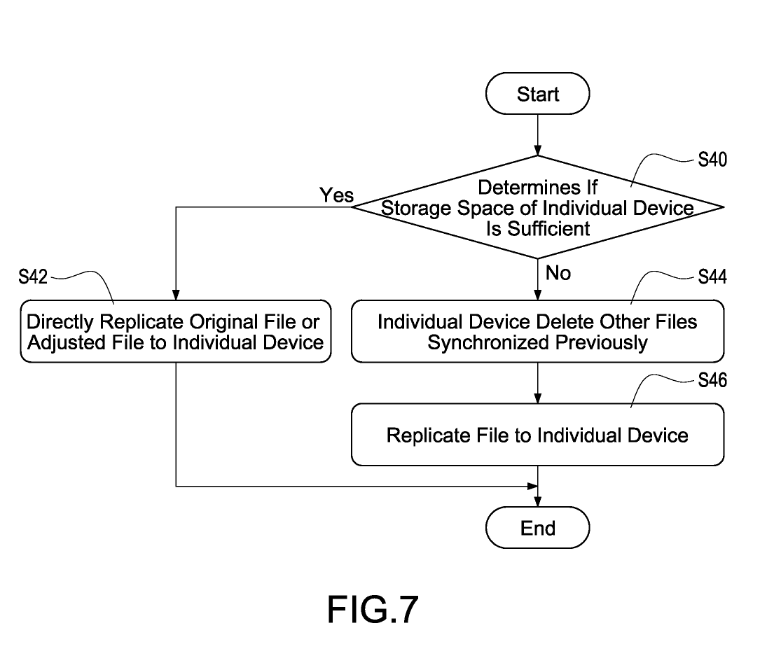

FIG. 7 is a file deleting flowchart of the first preferred embodiment of the present invention. In the embodiment, before the web storage server 3 synchronizes a file (the original file 5 or the adjusted file) to the individual device 4, the web storage server 3 also determines based on if the storage space of the individual device 4 is sufficient (step S40). If the storage space of the individual device 4 is sufficient, the web storage server 3 is allowed to directly replicate the original file 5 or the adjusted file to the individual device 4 (step S42) in order to complete the synchronizing procedure.

However, if the storage space of the individual device 4 is insufficient, then the individual device 4 can delete other files synchronized previously (step S44) to increase the storage space, then the web storage server 3 replicates the original file 5 or the adjusted file to the individual device 4 (step S46). In the embodiment, the individual device 4 determines which files to delete according to the order of the downloaded time (created time) of the files synchronized previously, or the value of the file using frequency. For example, delete the oldest synchronized file, or the least used file, in order to increase the storage space of the individual device 4, but are not limited thereto.

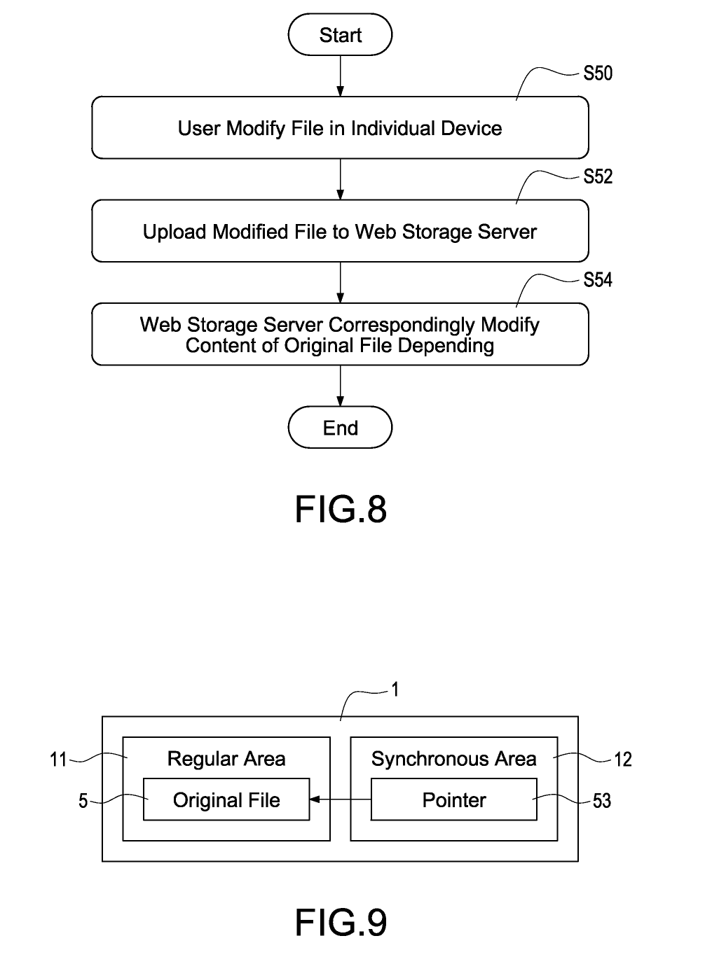

FIG. 8 is a file modifying flowchart of the first preferred embodiment of the present invention. After the original file 5 or the adjusted file is synchronized to the individual device 4, the user is allowed to use the file in the individual device 4. In addition, the user is allowed to modify the file in the individual device 4 (step S50). Based on the required synchronizing mechanism of the present invention, after the individual device 4 modifies the file, the modified file is uploaded to the web storage server 3 (step S52). Also, the web storage server 3 then correspondingly modifies the content of the original file 5 to generate modified original file 5 depending on the modified content of the modified file (step S54). Thus, the content of the modified files in the individual device 4 and the content of the modified original file 5 in the web storage server 3 are synchronized.

Next, the web storage server 3 re-synchronizes the modified original file 5 to the user terminal 1 and other individual devices 4, or adjusts the file size depending on the modified original file 5 then re-synchronize the modified original file 5 to the user terminal 1 and other individual devices 4. Thus, the file in the user terminal 1, the web storage server 3 and the individual devices 4 are synchronized.

It should be noted that, some synchronizing applications replicate a copy of the file, which the user wants to synchronize, to a synchronous area in the device, then the file in the synchronous area is synchronized to other devices. Thus, it becomes a concerning issue that there are two identical files saved in the device. The present invention provides solutions to the issue of the above mentioned type of the synchronizing applications.

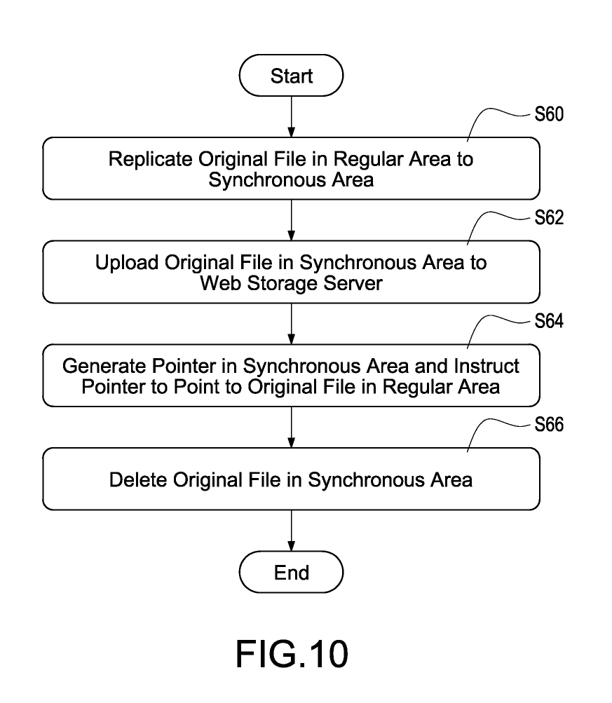

FIG. 9 is a storage device perspective diagram of the first preferred embodiment of the present invention and FIG. 10 is a file uploading flowchart of the second preferred embodiment of the present invention. In order to use the above mentioned synchronizing applications, the user terminal 1 allocates internal storage space into a regular area 11 and a synchronous area 12. The regular area 11 is used for saving the original file 5. Before the user terminal 1 uploads the original file 5 to the web storage server 3, the user replicates the original file 5 in the regular area 11 to the synchronous area 12 (step S60). Next, the original file 5 in the synchronous area 12 is uploaded to the web storage server 3 (step S62).

Next, the user terminal 1 generates a pointer 53 in the synchronous area 12, and instructs the pointer 53 to point to the original file 5 in the regular area 11 (step S64). Thus, the user terminal 1 is allowed to delete the original file 5 in the synchronous area 12 (step S66).

In the embodiment, when the web storage server 3 needs to synchronize the original file 5 in the web storage server 3 to the user terminal 1, the web storage server 3 first connects to the pointer 53 in the synchronous area 12, then instructs the pointer 53 to point to the original file 5 in the regular area 12, and modifies the original file 5 in the regular area 12. In the embodiment, the user terminal 1 retains a physical original file 5 in the regular area 11, and the other file in the synchronous area 12 is replaced with the pointer 53 pointing to the original file 5 in the regular area 11. Thus, the required storage space for the file is saved by 50%, and the synchronizing efficiency provided by associated technical steps is achieved. In addition, adding up the above mentioned file adjustments according to the differences of the individual devices 4, the storage space used with the synchronizing mechanism is further reduced.

As the skilled person will appreciate, various changes and modifications can be made to the described embodiments. It is intended to include all such variations, modifications and equivalents which fall within the scope of the invention, as defined in the accompanying claims.

What is claimed is:

1. A device-aware file synchronizing method, used among a user terminal, a web storage server and an individual device, wherein the user terminal, the web storage server and the individual device are connected via an interconnected network, the synchronizing method comprising:
a) receiving and saving an original file uploaded from the user terminal at the web storage server;
b) determining if the original file should be adjusted according to file types of the original file, or the capabilities of the individual device to synchronize with at the web storage server;
c) if the determining result in the step b is yes, adjusting the original file, and generating an adjusted file at the web storage server;
d) after the step c, replicating the adjusted file from the web storage server to the individual device;
e) if the determining result in the step b is no, replicating the original file from the web storage server to the individual device.

2. The device-aware file synchronizing method of claim 1, wherein in the step b, the web storage server determines if the original file should be adjusted according to computing capability of the individual device, display capability of the individual device, or storage space of the individual device.

3. The device-aware file synchronizing method of claim 2, wherein in the step c, the web storage server computes an optimized file size of the original file for the individual device via a function, wherein the variables used by the function is at least one of file type of the original file, processor clock of the individual device, display resolution of the individual device, and the available storage space of the individual device.

4. The device-aware file synchronizing method of claim 1, wherein the step b, the web storage server further determines if the original file should be adjusted according to file sizes of previously downloaded files of the individual device, download time order of previously downloaded files or using frequency of previously downloaded files.

5. The device-aware file synchronizing method of claim 1, wherein the method further comprises the following steps:
f) after step a, deleting the original file saved in the user terminal;
g) retaining file name of the original file of the user terminal; and
h) when the file name of the original file is used in the user terminal, the user terminal simultaneously downloading the original file corresponding to the file name from the web storage server.

6. The device-aware file synchronizing method of claim 5, wherein in the step h, the web storage server adjusts the original file according to the file type of the original file, or the capabilities of the user terminal, and downloads the adjusted file to the user terminal.

7. The device-aware file synchronizing method of claim 1, wherein the method further comprises the following steps:
i) modifying the adjusted file or the original file downloaded at the individual device, and generating a modified file;
j) uploading the modified file from the individual device to the web storage server; and
k) modifying the original file correspondingly according to the modified content of the modified file at the web storage server.

8. The device-aware file synchronizing method of claim 1, wherein the method further comprises the following steps:
l) after the step b, determining if the storage space of the individual device is sufficient; and
m) if the storage space of the individual device, deleting previous synchronized file in the individual device.

9. The device-aware file synchronizing method of claim 8, wherein in the step m, making a decision on which file to delete in the individual device according to created time order of the synchronized file in the individual device, or file using frequency of the synchronized file.

10. The device-aware file synchronizing method of claim 1, wherein the user terminal has a storage space, the storage space comprises a regular area and a synchronous area, the regular area is used for saving the original file, and the method further comprises the following steps before the step a:
a01) replicating the original file in the regular area to the synchronous area;
a02) uploading the original file in the synchronous area to the web storage server;
a03) generating a pointer in the synchronous area, and instructing the pointer pointing to the original file of the regular area; and
a04) deleting the original file in the synchronous area.
